(19) United States
(12) Patent Application Publication
(10) Pub. No.: US 2026/0136448 A1
(43) Pub. Date: May 14, 2026

(54) POWER CARRIER CIRCUIT AND LIGHTING DEVICE

(71) Applicants: SUZHOU OPPLE LIGHTING CO., LTD., Suzhou City (CN); OPPLE LIGHTING CO., LTD., Shanghai (CN)

(72) Inventors: Chun GAO, Suzhou City (CN); Guangchuan ZHU, Suzhou City (CN)

(73) Assignees: SUZHOU OPPLE LIGHTING CO., LTD., Suzhou City, Jiangsu (CN); OPPLE LIGHTING CO., LTD., Shanghai (CN)

(21) Appl. No.: 19/434,101

(22) Filed: Dec. 29, 2025

Related U.S. Application Data
(63) Continuation of application No. PCT/CN2024/098645, filed on Jun. 12, 2024.

(30) Foreign Application Priority Data
Jun. 30, 2023 (CN) 202310802220.5
Jun. 30, 2023 (CN) 202321713456.3

(51) Int. Cl. H05B 47/185; H05B 45/10; H05B 45/325; H05B 45/36; H05B 45/37

(52) U.S. Cl. CPC H05B 47/185; H05B 45/10; H05B 45/325; H05B 45/36; H05B 45/37

(57) ABSTRACT

The present disclosure relates to the technical field of circuits. Provided are a power carrier circuit and a lighting device. A carrier modulates a carrier signal into an alternating current of a first power source line, so as to obtain an alternating-current carrier control signal; a rectifier converts into a direct current the alternating-current carrier control signal transmitted by the first power source line; a first coupler is used for filtering out a direct-current signal and a low-frequency signal in the alternating-current carrier control signal, and retaining a high-frequency signal in the alternating-current carrier control signal, where the target carrier signal and the first direct-current signal are modulated in a second power source line; a second coupler is used for performing coupling on the direct-current power source carrier signal to obtain the target carrier signal, and transmitting the target carrier signal to a lighting module.

### CROSS-REFERENCE TO RELATED APPLICATION

This disclosure is based upon and claims the priority of PCT patent disclosure No. PCT/CN2024/098645 filed on Jun. 12, 2024, which claims priority to the Chinese patent disclosure No. 202310802220.5 filed on Jun. 30, 2023 and the Chinese patent disclosure No. 202321713456.3 filed on Jun. 30, 2023, the entire contents of which are hereby incorporated by reference herein for all purposes.

### TECHNICAL FIELD

The present disclosure relates to the field of circuit technology, and in particular to a power carrier circuit and a lighting device.

### BACKGROUND

With the continuous development of technology, lighting devices have become indispensable in people's lives. In addition to simply controlling the on/off of lighting devices through switches, it is now also possible to control their brightness, timed on/off and other functions through specific signals.

### SUMMARY

The present disclosure provides a power carrier circuit and a lighting device.

The present disclosure provides a power carrier circuit, and the power carrier circuit may include:
a carrier, and an output end of the carrier that may be connected to a first power line, and the carrier may be configured to modulate a carrier signal into an alternating current of the first power line to obtain an alternating-current carrier control signal;
a rectifier, and an input end of the rectifier may be connected to the first power line, and the rectifier may be configured to convert the alternating-current carrier control signal transmitted by the first power line into direct current to obtain a first direct-current signal;
a first coupler, and a first port of the first coupler may be connected to the first power line, the first coupler may be configured to filter out a direct-current signal and a low-frequency signal in the alternating-current carrier control signal, and retain a high-frequency signal in the alternating-current carrier control signal to obtain a target carrier signal; the target carrier signal and the first direct-current signal may be modulated in a second power line to obtain a direct-current power carrier signal; and
N decoding lighting units, each decoding lighting unit including a second coupler and a lighting module which may be communicatively connected, N being a positive integer; an output end of the rectifier and a second port of the first coupler may be connected to the second coupler and the lighting module in the each decoding lighting unit through the second power line; wherein the second coupler may be configured to couple the target carrier signal from the direct-current power carrier signal and transmit the target carrier signal to the lighting module, and the lighting module may be configured to extract power based on the direct-current power carrier signal and operate according to the target carrier signal.

The present disclosure further provides a lighting device, including any one of the above-mentioned power carrier circuits.

It is to be understood that both the foregoing general description and the following detailed description are exemplary and explanatory only and are not restrictive of the present disclosure.

### BRIEF DESCRIPTION OF DRAWINGS

In order to more clearly illustrate the technical solutions in the present disclosure, the drawings required for describing the examples will be briefly introduced below. The drawings in the following description are some examples of the present disclosure. For those of ordinary skill in the art, other drawings can also be obtained according to these drawings without creative work.

FIG. 1 is a first schematic structural diagram of a power carrier circuit provided by an example of the present disclosure;

FIG. 2 is a second schematic structural diagram of a power carrier circuit provided by an example of the present disclosure;

FIG. 3 is a third schematic structural diagram of a power carrier circuit provided by an example of the present disclosure;

FIG. 4 is a fourth schematic structural diagram of a power carrier circuit provided by an example of the present disclosure; and

FIG. 5 is a schematic structural diagram of a lighting device provided by an example of the present disclosure.

### DETAILED DESCRIPTION

In order to make the purpose, technical solutions and advantages of the present disclosure clearer, the technical solutions in the present disclosure will be clearly and completely described below in conjunction with the drawings in the present disclosure. The described examples are part of the examples of the present disclosure, not all of them. Based on the examples in the present disclosure, all other examples obtained by those of ordinary skill in the art without creative work belong to the scope of protection of the present disclosure.

In some implementations, the functions of power supply and signal transmission are realized through a four-wire system. The four-wire system includes four independent signal lines, namely a positive line, a negative line, a data line and a ground line. In the four-wire system, the positive line provides the positive voltage of the power supply or signal, the negative line provides the negative voltage of the power supply or signal, the data line is used to transmit specific audio, video or data signals, and the ground line is used to provide a common ground reference point to ensure the accuracy and stability of the signals. However, the four-wire system consumes more wires, and due to the excessive number of wires, the probability of failure is relatively higher. Therefore, how to better realize the control of lighting devices has become an urgent problem to be solved in the industry.

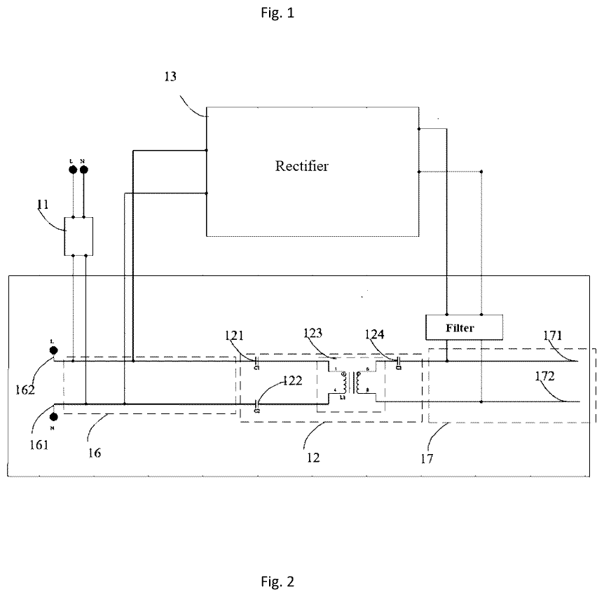

FIG. 1 is a first schematic structural diagram of a power carrier circuit provided by an example of the present disclosure. As shown in FIG. 1, the circuit includes: a carrier 11, a first coupler 12, a rectifier 13, and N decoding lighting units 18. The decoding lighting unit 18 includes a second coupler 14 and a lighting module 15.

The output end of the carrier 11 is connected to the first power line 16, and the carrier 11 modulates the carrier signal into the alternating current of the first power line 16 to obtain an alternating-current carrier control signal.

Both the first port of the first coupler 12 and the input end of the rectifier 13 are connected to the first power line 16.

The rectifier 13 converts the alternating-current carrier control signal transmitted by the first power line 16 into direct current to obtain a first direct-current signal.

The first coupler 12 is configured to filter out the direct-current signal and the low-frequency signal in the alternating-current carrier control signal, and retain the high-frequency signal in the alternating-current carrier control signal to obtain a target carrier signal.

The second port of the first coupler 12 and the output end of the rectifier 13 are connected to the second coupler 14 and the lighting module 15 in each decoding lighting unit 18 through the second power line 17, and the second coupler 14 is communicatively connected to the lighting module 15.

The target carrier signal and the first direct-current signal are modulated in the second power line 17 to obtain a direct-current power carrier signal.

The second coupler 14 is configured to couple the target carrier signal from the direct-current power carrier signal and transmit the target carrier signal to the lighting module 15.

The lighting module 15 extracts power through the direct-current power carrier signal and operates according to the target carrier signal.

In the example of the present disclosure, the first power line may specifically be connected to an alternating-current power supply, and the alternating-current power supply provides alternating current for the first power line. For example, the alternating-current power supply provides 220V alternating current or 110V alternating current for the first power line.

The carrier in the example of the present disclosure can modulate the carrier signal that is configured to control the lighting device into the alternating current of the first power line. The alternating-current carrier control signal obtained in this way is still transmitted in the first power line, not only has the characteristics of alternating current but also can carry the information of the carrier signal.

In the example of the present disclosure, the alternating-current carrier control signal will be transmitted to the first coupler and the rectifier, respectively. The rectifier is configured to convert the alternating-current signal into a direct-current signal. Its main function is to convert the variable voltage of the alternating-current power supply into a stable direct-current voltage to supply power to electronic equipment and circuits. Therefore, the rectifier in the present disclosure will convert the alternating-current carrier control signal into direct current to obtain the first direct-current signal.

The first coupler in the example of the present disclosure will specifically filter out the direct-current component in the alternating-current carrier control signal, retain the alternating-current signal component, and can further filter out the low-frequency component in the signal, couple and transmit the high-frequency signal downstream to obtain the target carrier signal, which is then transmitted to the second power line.

In the example of the present disclosure, after the rectifier transmits the first direct-current signal to the second power line and the first coupler transmits the target carrier signal to the second power line, the target carrier signal and the first direct-current signal will be loaded together to obtain a direct-current power carrier signal. The direct-current power carrier signal can supply power and also carry the target carrier signal configured to control the lighting module.

In the example of the present disclosure, the second power line can directly transmit the direct-current power carrier signal to the lighting module, thereby realizing power supply for the lighting module. On the other hand, the second coupler can effectively couple, from the direct-current power carrier signal, the target carrier signal configured to control the operation of the lighting module and transmit the target carrier signal to the lighting module, thereby realizing the control of the operation of the lighting module.

In the example of the present disclosure, the carrier signal is modulated into alternating current to obtain an alternating-current carrier control signal. The signal transmission of the alternating-current carrier control signal only requires a first power line including two wires. Subsequently, the first coupler can be used to filter out the direct-current signal and low-frequency signal in the alternating-current carrier control signal, and retain the high-frequency signal in the alternating-current carrier control signal to obtain the target carrier signal. After the rectifier converts the alternating-current carrier control signal into direct current, the first direct-current signal is modulated in the second power line including only two wires to obtain a direct-current power carrier signal. The direct-current power carrier signal can supply power to the lighting module, and at the same time the second coupler can also couple the target carrier signal from the direct-current power carrier signal, thereby realizing the control of the operation of the lighting module according to the target carrier signal. The power carrier circuit in the present disclosure can realize power supply and signal transmission through only two wires, which can effectively reduce the usage rate of wires and the risk of failure caused by excessive wires.

Optionally, FIG. 2 is a second schematic structural diagram of a power carrier circuit provided by an example of the present disclosure. In this example, the first power line 16 includes a neutral line 161 and a live line 162; the second power line 17 includes a positive line 171 and a negative line 172; the first coupler 12 includes a first capacitor 121, a second capacitor 122, a first transformer 123 and a third capacitor 124.

The first capacitor 121 is connected to the live line 162 and the first port of the first transformer 123, respectively; and the second capacitor 122 is connected to the neutral line 161 and the second port of the first transformer 123, respectively.

The first capacitor 121 and the second capacitor 122 are configured to filter out the direct-current signal in the alternating-current carrier control signal to obtain a first carrier signal; the first transformer 123 is configured to filter out the low-frequency signal in the first carrier signal to obtain a second carrier signal.

The third capacitor 124 is connected to the third port of the first transformer 123 and the positive line 171, respectively; and the fourth port of the first transformer 123 is connected to the negative line 172.

The third capacitor 124 is configured to filter out the direct-current signal in the second carrier signal to obtain a target carrier signal, and transmit the target carrier signal to the second power line 17.

Specifically, in the example of the present disclosure, the first capacitor and the second capacitor are arranged on the neutral line and the live line of the first power line, respectively, so that the direct-current signal in the alternating-current carrier control signal is filtered out through the first capacitor and the second capacitor to obtain the first carrier signal. Then, the first carrier signal is transmitted to the first transformer. The first transformer specifically filters out the low-frequency component in the first carrier signal, then couples and transmits the high-frequency signal downstream. In addition, the first transformer can also realize safety isolation of the signal to obtain the second carrier signal.

In an optional example, the first transformer may be an isolation transformer.

In the example of the present disclosure, after the first transformer obtains the second carrier signal, it can be transmitted to the third capacitor. At this time, the third capacitor can further filter out the direct-current signal in the second carrier signal to finally obtain the target carrier signal, and transmit the target carrier signal to the second power line.

In the example of the present disclosure, the first coupler can effectively filter out the direct-current signal and low-frequency signal in the alternating-current carrier control signal, retain the high-frequency signal, and finally obtain the target carrier signal. At the same time, the first transformer in the first coupler can also effectively realize signal isolation and ensure stable signal transmission.

Optionally, the circuit further includes a power amplifier, and the power amplifier is connected to the second port of the first coupler and the second power line, respectively.

The power amplifier is configured to perform power amplification on the target carrier signal and then transmit the target carrier signal after the power amplification to the second power line.

In the example of the present disclosure, since many other devices may be connected to the first power line, the target carrier signal coupled by the first coupler has already experienced a certain degree of attenuation, which is not conducive to subsequent signal transmission. Therefore, a power amplifier connected to the first coupler can be further provided in the example of the present disclosure.

In the example of the present disclosure, after the first coupler outputs the target carrier signal, it is first amplified by the power amplifier before being input into the second power line.

In the example of the present disclosure, the power amplifier effectively avoids the problem of attenuation of the target carrier signal and ensures effective transmission of the signal.

Optionally, the circuit further includes a filter, and the filter is connected to the output end of the rectifier and the second power line, respectively.

The filter is configured to filter out the high-frequency differential mode signal in the first direct-current signal.

In the example of the present disclosure, after the rectifier converts the alternating-current carrier control signal into direct current to obtain the first direct-current signal, in order to improve the quality of the direct-current signal, the high-frequency differential mode signal in the first direct-current signal can be further filtered out through the filter, thereby effectively preventing the high-frequency signal in the direct current from interfering with the control signal component in the target carrier signal, and enabling the direct-current power carrier signal to satisfy the requirements of no crosstalk and low attenuation in the subsequent decoding process.

In the example of the present disclosure, the filter can effectively filter out the high-frequency differential mode signal in the first direct-current signal, thereby effectively preventing the high-frequency signal in the direct-current signal from interfering with the target carrier signal.

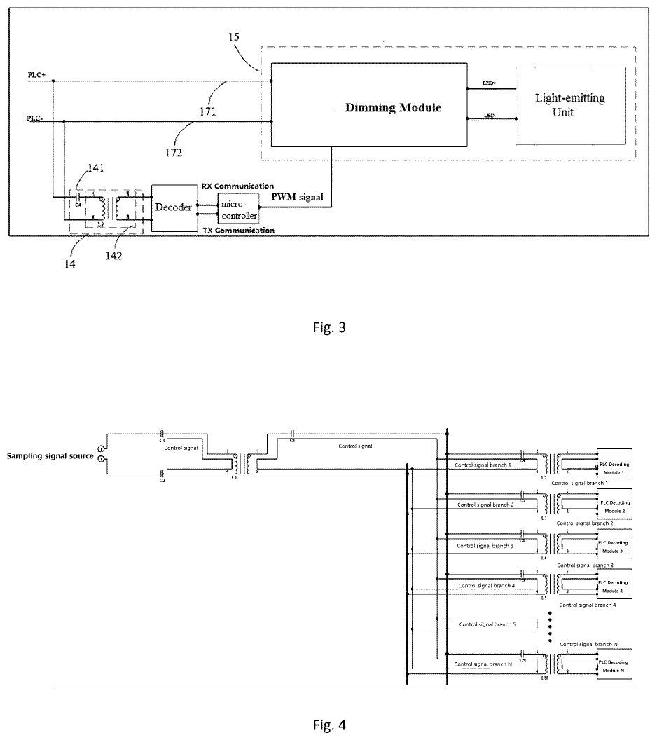

Optionally, FIG. 3 is a third schematic structural diagram of a power carrier circuit provided by an example of the present disclosure. As shown in FIG. 3, the second coupler 14 includes a fourth capacitor 141 and a second transformer 142.

The fourth capacitor 141 is connected to the positive line 171 and the first port of the second transformer 142, respectively; the second port of the second transformer 142 is connected to the negative line 172; and the third port and the fourth port of the second transformer 142 are connected to the lighting module 15.

The fourth capacitor 141 is configured to filter out the low-frequency signal in the direct-current power carrier signal; the second transformer 142 is configured to couple the target carrier signal from the direct-current power carrier signal and transmit the target carrier signal to the lighting module 15.

In the example of the present disclosure, the fourth capacitor can be configured to filter out the low-frequency component in the target carrier signal, retain the high-frequency component in the target carrier signal, and transmit the filtered target carrier signal to the second transformer for processing.

On the other hand, the fourth capacitor can also effectively avoid a short circuit caused by the first port and the second port of the first transformer directly connecting to the positive line and the negative line.

In the example of the present disclosure, the second transformer can couple the target carrier signal from the direct-current power carrier signal, and then transmit the target carrier signal to the lighting module, so that the lighting module can obtain the target carrier signal for controlling lighting while realizing power supply through the second power line.

Optionally, the circuit further includes a decoder, the first port of the decoder is connected to the third port and the fourth port of the second transformer, and the second port of the decoder is communicatively connected to the lighting module.

The decoder is configured to decode the target carrier signal into a pulse width modulation signal and transmit the pulse width modulation signal to the lighting module.

In the example of the present disclosure, the decoder may specifically refer to decoding the target carrier signal transmitted by the second transformer into a pulse width modulation signal, and the control of the lighting module can be realized more conveniently through the pulse width modulation signal.

Optionally, the circuit further includes a microcontroller, and the microcontroller is communicatively connected to the decoder and the lighting module, respectively.

The microcontroller is configured to control the operation of the lighting module through the pulse width modulation signal.

In the example of the present disclosure, there are receiving communication and sending communication between the microcontroller and the decoder. The decoder can send the decoded pulse width modulation signal to the microprocessor. The microprocessor can control the operation of the lighting module through the pulse width modulation signal according to the execution command, such as controlling the brightness modulation of the lighting module.

In an optional example, the control functions performed by the microcontroller are all existing control functions, which are not limited in the example of the present disclosure.

In the example of the present disclosure, the decoder and the controller can effectively convert the target carrier signal into a pulse width modulation signal that is easy to process, and the microcontroller can effectively realize the lighting control of the lighting module according to the pulse width modulation signal.

Optionally, the lighting module includes a dimming module and a light-emitting unit; the dimming module is connected to the second power line and the second coupler, respectively.

The dimming module is configured to control the brightness of the light-emitting unit according to the target carrier signal.

In the example of the present disclosure, the dimming module may specifically be a module configured to control the brightness of the light-emitting unit according to the target carrier signal. Specifically, it can control the light-emitting unit to brighten or dim, and can also control the light-emitting unit to turn on or turn off at a scheduled time.

In an optional example, the dimming module also transmits the direct-current power carrier signal transmitted by the second power line to the light-emitting unit to supply power to the light-emitting unit.

In an optional example, the light-emitting unit may specifically be a light-emitting diode, a laser diode, an organic light-emitting diode and other light-emitting units.

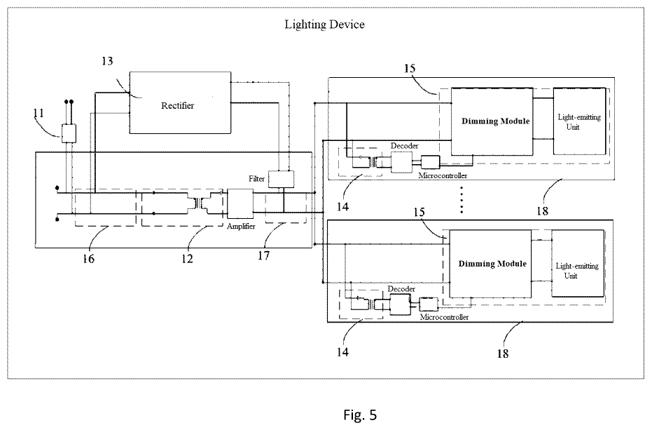

In an optional example, FIG. 4 is a fourth schematic structural diagram of a power carrier circuit provided by an example of the present disclosure. As shown in FIG. 4, the coupling path of the control signal may specifically be that after being coupled to the bus through bus sampling, each branch circuit performs coupling sampling of the control information.

In some optional examples, FIG. 5 is a schematic structural diagram of a lighting device provided by an example of the present disclosure. As shown in FIG. 5, the lighting device includes the power carrier circuit described in the above examples. For the specific content of the power carrier circuit, reference may be made to the above examples, which will not be repeated here.

Optionally, in an optional example, the first power line and the second power line in the power carrier circuit may specifically be power lines installed in a magnetic track to realize magnetic attraction power supply. For the specific content of the electronic carrier circuit, reference may be made to the above examples, which will not be repeated here.

Further, the lighting device provided by the present disclosure is equipped with the power carrier circuit as described above, and hence also has the various advantages as mentioned above.

The present disclosure provides a power carrier circuit and a lighting device to solve the defects in other implementations that the four-wire system consumes more wires and has a relatively higher probability of failure due to the excessive number of wires.

The present disclosure provides a power carrier circuit, including:
a carrier, an output end of the carrier being connected to a first power line, and the carrier being configured to modulate a carrier signal into an alternating current of the first power line to obtain an alternating-current carrier control signal;
a rectifier, an input end of the rectifier being connected to the first power line, and the rectifier being configured to convert the alternating-current carrier control signal transmitted by the first power line into direct current to obtain a first direct-current signal;
a first coupler, a first port of the first coupler being connected to the first power line, the first coupler being configured to filter out a direct-current signal and a low-frequency signal in the alternating-current carrier control signal, and retain a high-frequency signal in the alternating-current carrier control signal to obtain a target carrier signal; the target carrier signal and the first direct-current signal being modulated in a second power line to obtain a direct-current power carrier signal; and
N decoding lighting units, each decoding lighting unit including a second coupler and a lighting module which are communicatively connected, N being a positive integer; an output end of the rectifier and a second port of the first coupler being connected to the second coupler and the lighting module in the each decoding lighting unit through the second power line; wherein the second coupler is configured to couple the target carrier signal from the direct-current power carrier signal and transmit the target carrier signal to the lighting module, and the lighting module is configured to extract power based on the direct-current power carrier signal and operate according to the target carrier signal.

According to a power carrier circuit provided by the present disclosure, the circuit further includes: a power amplifier, wherein the power amplifier is connected to the second port of the first coupler and the second power line, respectively, and the power amplifier is configured to perform power amplification on the target carrier signal and then transmit the target carrier signal after the power amplification to the second power line.

According to a power carrier circuit provided by the present disclosure, the first power line includes a neutral line and a live line; the second power line includes a positive line and a negative line; and the first coupler includes:
a first capacitor, a second capacitor and a first transformer, wherein the first capacitor is connected to the live line and a first port of the first transformer, respectively, and the second capacitor is connected to the neutral line and a second port of the first transformer, respectively; the first capacitor and the second capacitor are configured to filter out the direct-current signal in the alternating-current carrier control signal to obtain a first carrier signal; the first transformer is configured to filter out the low-frequency signal in the first carrier signal to obtain a second carrier signal;
a third capacitor, wherein the third capacitor is connected to a third port of the first transformer and the positive line, respectively, and a fourth port of the first transformer is connected to the negative line; the third capacitor is configured to filter out the direct-current signal in the second carrier signal to obtain the target carrier signal and transmit the target carrier signal to the second power line.

According to a power carrier circuit provided by the present disclosure, the second coupler includes: a fourth capacitor and a second transformer, wherein the fourth capacitor is connected to the positive line and a first port of the second transformer, respectively; a second port of the second transformer is connected to the negative line; a third port and a fourth port of the second transformer are connected to the lighting module; the fourth capacitor is configured to filter out the low-frequency signal in the direct-current power carrier signal; and the second transformer is configured to couple the target carrier signal from the direct-current power carrier signal and transmit the target carrier signal to the lighting module.

According to a power carrier circuit provided by the present disclosure, the circuit further includes: a decoder, wherein a first port of the decoder is connected to the third port and the fourth port of the second transformer; a second port of the decoder is communicatively connected to the lighting module; and the decoder is configured to decode the target carrier signal into a pulse width modulation signal and transmit the pulse width modulation signal to the lighting module.

According to a power carrier circuit provided by the present disclosure, the circuit further includes: a microcontroller, wherein the microcontroller is communicatively connected to the decoder and the lighting module, respectively, and the microcontroller is configured to control an operation of the lighting module through the pulse width modulation signal.

According to a power carrier circuit provided by the present disclosure, the circuit further includes: a filter, wherein the filter is connected to the output end of the rectifier and the second power line, respectively, and the filter is configured to filter out a high-frequency differential mode signal in the first direct-current signal.

According to a power carrier circuit provided by the present disclosure, the lighting module includes: a dimming module and a light-emitting unit, wherein the dimming module is connected to the second power line and the second coupler, respectively, and the dimming module is configured to control a brightness of the light-emitting unit according to the target carrier signal.

According to a power carrier circuit provided by the present disclosure, the light-emitting unit includes at least one of: a light-emitting diode, a laser diode, an organic light-emitting diode and other light-emitting units.

The present disclosure further provides a lighting device, including any one of the above-mentioned power carrier circuits.

In the power carrier circuit and the lighting device provided by the present disclosure, the carrier signal is modulated into alternating current to obtain an alternating-current carrier control signal. The signal transmission of the alternating-current carrier control signal only requires a first power line including two wires. Subsequently, the first coupler can be used to filter out the direct-current signal and low-frequency signal in the alternating-current carrier control signal, and retain the high-frequency signal in the alternating-current carrier control signal to obtain the target carrier signal. After the rectifier converts the alternating-current carrier control signal into direct current, the first direct-current signal is modulated in the second power line including only two wires to obtain a direct-current power carrier signal. The direct-current power carrier signal can supply power to the lighting module, and at the same time the second coupler can also couple the target carrier signal from the direct-current power carrier signal, thereby realizing the control of the operation of the lighting module according to the target carrier signal. The power carrier circuit in the present disclosure can realize power supply and signal transmission through only two wires, which can effectively reduce the usage rate of wires and the risk of failure caused by excessive wires.

The device examples described above are only illustrative. The units described as separate components may or may not be physically separated, and the components shown as units may or may not be physical units, that is, they may be located at the same place, or may be distributed on multiple network units. Some or all of the modules may be selected according to actual needs to achieve the purpose of the solutions of these examples. Those of ordinary skill in the art can understand and implement the present disclosure without creative work.

Through the description of the above implementation modes, those skilled in the art can clearly understand that each implementation mode can be realized by means of software combined with a necessary universal hardware platform, and certainly can also be realized by hardware. Based on such understanding, the essence of the above technical solutions or the part that contributes to the some other implementations can be embodied in the form of software products. The computer software products can be stored in a computer-readable storage medium, such as ROM/RAM, magnetic disks, optical disks, etc., and include several instructions to enable a computer device (which may be a personal computer, a server, or a network device, etc.) to execute the methods described in each example or certain parts of the examples.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

Finally, it should be noted that the above examples are only used to illustrate the technical solutions of the present disclosure, but not to limit them. Although the present disclosure has been described in detail with reference to the foregoing examples, those of ordinary skill in the art should understand that they can still modify the technical solutions described in the foregoing examples, or replace some of the technical features with equivalents. These modifications or replacements do not cause the essence of the corresponding technical solutions to deviate from the scope of the technical solutions of the various example of the present disclosure.

1. A power carrier circuit, comprising:
a carrier, wherein an output end of the carrier is connected to a first power line, and the carrier is configured to modulate a carrier signal into an alternating current of the first power line to obtain an alternating-current carrier control signal;
a rectifier, wherein an input end of the rectifier is connected to the first power line, and the rectifier is configured to convert the alternating-current carrier control signal transmitted by the first power line into direct current to obtain a first direct-current signal;
a first coupler, wherein a first port of the first coupler is connected to the first power line, the first coupler is configured to filter out a direct-current signal and a low-frequency signal in the alternating-current carrier control signal, and retain a high-frequency signal in the alternating-current carrier control signal to obtain a target carrier signal; the target carrier signal and the first direct-current signal are modulated in a second power line to obtain a direct-current power carrier signal; and
N decoding lighting units, each decoding lighting unit comprising a second coupler and a lighting module which are communicatively connected, N being a positive integer; wherein an output end of the rectifier and a second port of the first coupler are connected to the second coupler and the lighting module in the each decoding lighting unit through the second power line; and wherein the second coupler is configured to couple the target carrier signal from the direct-current power carrier signal and transmit the target carrier signal to the lighting module, and the lighting module is configured to extract power based on the direct-current power carrier signal and operate according to the target carrier signal.

2. The power carrier circuit according to claim 1, further comprising:
a power amplifier, wherein the power amplifier is connected to the second port of the first coupler and the second power line, and the power amplifier is configured to perform power amplification on the target carrier signal and then transmit the target carrier signal after the power amplification to the second power line.

3. The power carrier circuit according to claim 1, wherein the first power line comprises a neutral line and a live line, the second power line comprises a positive line and a negative line; and the first coupler comprises:
a first capacitor, a second capacitor and a first transformer, wherein the first capacitor is connected to the live line and a first port of the first transformer, and the second capacitor is connected to the neutral line and a second port of the first transformer; the first capacitor and the second capacitor are configured to filter out the direct-current signal in the alternating-current carrier control signal to obtain a first carrier signal; and the first transformer is configured to filter out the low-frequency signal in the first carrier signal to obtain a second carrier signal; and
a third capacitor, wherein the third capacitor is connected to a third port of the first transformer and the positive line, and a fourth port of the first transformer is connected to the negative line; and the third capacitor is configured to filter out the direct-current signal in the second carrier signal to obtain the target carrier signal and transmit the target carrier signal to the second power line.

4. The power carrier circuit according to claim 3, wherein the second coupler comprises:
a fourth capacitor and a second transformer, wherein the fourth capacitor is connected to the positive line and a first port of the second transformer; a second port of the second transformer is connected to the negative line; a third port and a fourth port of the second transformer are connected to the lighting module; the fourth capacitor is configured to filter out the low-frequency signal in the direct-current power carrier signal; and the second transformer is configured to couple the target carrier signal from the direct-current power carrier signal and transmit the target carrier signal to the lighting module.

5. The power carrier circuit according to claim 4, further comprising: a decoder, wherein
a first port of the decoder is connected to the third port and the fourth port of the second transformer; a second port of the decoder is communicatively connected to the lighting module; and the decoder is configured to decode the target carrier signal into a pulse width modulation signal and transmit the pulse width modulation signal to the lighting module.

6. The power carrier circuit according to claim 5, further comprising:
a microcontroller, wherein the microcontroller is communicatively connected to the decoder and the lighting module, and the microcontroller is configured to control an operation of the lighting module through the pulse width modulation signal.

7. The power carrier circuit according to claim 1, further comprising:
a filter, wherein the filter is connected to the output end of the rectifier and the second power line, and the filter is configured to filter out a high-frequency differential mode signal in the first direct-current signal.

8. The power carrier circuit according to claim 1, wherein the lighting module comprises:
a dimming module and a light-emitting unit, wherein the dimming module is connected to the second power line and the second coupler, and the dimming module is configured to control a brightness of the light-emitting unit according to the target carrier signal.

9. The power carrier circuit according to claim 8, wherein the light-emitting unit comprises at least one of: a light-emitting diode, a laser diode, an organic light-emitting diode and other light-emitting units.

10. A lighting device, comprising a power carrier circuit, wherein the power carrier circuit comprises:
a carrier, wherein an output end of the carrier is connected to a first power line, and the carrier is configured to modulate a carrier signal into an alternating current of the first power line to obtain an alternating-current carrier control signal;
a rectifier, wherein an input end of the rectifier is connected to the first power line, and the rectifier is configured to convert the alternating-current carrier control signal transmitted by the first power line into direct current to obtain a first direct-current signal;
a first coupler, wherein a first port of the first coupler is connected to the first power line, the first coupler is configured to filter out a direct-current signal and a low-frequency signal in the alternating-current carrier control signal, and retain a high-frequency signal in the alternating-current carrier control signal to obtain a target carrier signal; the target carrier signal and the first direct-current signal are modulated in a second power line to obtain a direct-current power carrier signal; and
N decoding lighting units, each decoding lighting unit comprising a second coupler and a lighting module which are communicatively connected, N being a positive integer; wherein an output end of the rectifier and a second port of the first coupler are connected to the second coupler and the lighting module in the each decoding lighting unit through the second power line; and wherein the second coupler is configured to couple the target carrier signal from the direct-current power carrier signal and transmit the target carrier signal to the lighting module, and the lighting module is configured to extract power based on the direct-current power carrier signal and operate according to the target carrier signal.
